(19) United States
(12) Patent Application Publication
(10) Pub. No.: US 2007/0086449 A1
(43) Pub. Date: Apr. 19, 2007

(54) System and method for remote management

(75) Inventors: Shih-Yuan Huang, Taipei Hsien (TW); Chih-Tao Hsieh, Taipei Hsien (TW)

Correspondence Address: BIRCH STEWART KOLASCH & BIRCH, PO BOX 747, FALLS CHURCH, VA, 22040-0747, US

(73) Assignee: ATEN INTERNATIONAL CO., LTD, Taipei Hsien (TW)

(21) Appl. No.: 11/254,029

(22) Filed: Oct. 18, 2005

(51) Int. Cl. H04L 12/56

(52) U.S. Cl. 370/389

(57) ABSTRACT

A remote management system including an IPMI enabled server, an IPMI enabled client and a network device is provided. The IPMI enabled server is coupled to a first network and the IPMI enabled client is coupled to a second network. The network device is coupled between the first network and the second network for assigning a virtual IP address to the IPMI enabled client, in which the virtual IP belongs to the first network, so that the IPMI enabled server can use the virtual IP address to transmit at least one IPMI message to the IPMI enabled client.

### BACKGROUND OF THE INVENTION

1. Field of Invention

The present invention relates to a remote management system, and more particularly, to a system and method for remote management of an IPMI enabled computer, such as an IPMI enabled server in a network environment.

2. Related Art

Due to the fast development of network technology, computer systems are often composed of various devices, such as servers, storage devices, network devices and telecommunication devices distributed at different locations. In order to effectively manage the devices at different locations, a remote management system becomes important.

One standard for remote management, known as the Intelligent Platform Management Interface (IPMI), defines a common and secure interface to how various hardware vendors monitor their systems, log important system events and allow users to manage systems remotely.

FIG. 1 depicts a schematic diagram of a conventional remote management system. Referring to FIG. 1, the system includes at least one IPMI enabled client 11 and at least one IPMI enabled server 12. The IPMI enabled client 11 executes a console program that creates a session with the IPMI enabled server 12 via a first network 13, which is a local area network (LAN), so that users can manage the IPMI enabled server 12 remotely without having to visit the IPMI enabled server 12. However, the IPMI enabled client 11 and the IPMI enabled server 12 must be in the same network, i.e., the remote management system can only be implemented in LAN environments and not in wide-area network (WAN) environments.

FIG. 2 depicts a schematic diagram of another conventional remote management system. Referring to FIG. 2, the system includes at least one IPMI enabled client 11, a network device 14, an IPMI proxy appliance 15 and at least one IPMI enabled server 12. The IPMI enabled server 12 and the IPMI enabled client 11 are coupled to a first network 13 and a second network 16 respectively. In general, the first network 13 is a LAN and the second network 16 is a wide area network (WAN). The network device 14 being coupled between the first network 13 and the second network 16 can be a gateway, a router or a bridge. The IPMI proxy appliance 15 routes the IPMI messages, so that the remote management system can be implemented in WAN environments. However, adding the IPMI proxy appliance 15 increases cost.

### SUMMARY OF THE INVENTION

An objective of the invention is to provide a remote management system and method to control IPMI enabled servers remotely in WAN environments.

Another objective of the invention is to provide a remote management system and method to control IPMI enabled servers remotely in WAN environments without having to add an extra IPMI proxy appliance, so that the cost of the remote management system can be lowered.

Accordingly, the invention provides a remote management system including an IPMI enabled server, an IPMI enabled client and a network device. The IPMI enabled server is coupled to a first network and the IPMI enabled client is coupled to a second network. The network device is coupled between the first network and the second network for assigning a virtual IP address to the IPMI enabled client, in which the virtual IP belongs to the first network, so that the IPMI enabled server and the IPMI enabled client have the same Network ID and the IPMI enabled server can use the virtual IP address to transmit at least one IPMI message to the IPMI enabled client.

The invention also provides a network device for managing an IPMI enabled server using an IPMI enabled client. The network device is coupled between the first network and the second network. The IPMI enabled server is coupled to the first network and the IPMI enabled client is coupled to the second network. The network device includes a memory for storing a first software and a processor for executing the first software. The first software assigns a virtual IP address to the IPMI enabled client, in which the virtual IP address belongs to the first network, so that the IPMI enabled server and the IPMI enabled client have the same Network ID and the IPMI enabled server can use the virtual IP address to transmit at least one IPMI message to the IPMI enabled client.

The invention also provides a remote management method for managing an IPMI enabled server using an IPMI enabled client via a network device. The IPMI enabled server is coupled to a first network, the IPMI enabled client is coupled to a second network, and the network device is coupled between the first network and the second network, the remote management method includes transmitting a request from the IPMI enabled client to the network device, assigning a virtual IP address from the network device to the IPMI enabled client and then transmitting an IPMI message from the IPMI enabled server to the IPMI enabled client using the virtual IP address.

### BRIEF DESCRIPTION OF THE DRAWINGS

These and other features, aspects and advantages of the invention will become apparent by reference to the following description and accompanying drawings which are given by way of illustration only, and thus are not limitative of the invention, wherein:

FIG. 1 is a schematic diagram of a conventional remote management system;

FIG. 2 is a schematic diagram of another conventional remote management system;

FIG. 3 is a schematic diagram of the remote management system of the present invention;

FIG. 4 is a flow chart of a method for enabling a client to manage a server remotely via the network device described in FIG. 3;

FIG. 5 is a block diagram of a first software executed in the network device; and

FIG. 6 depicts a block diagram of the first software described in FIG. 5.

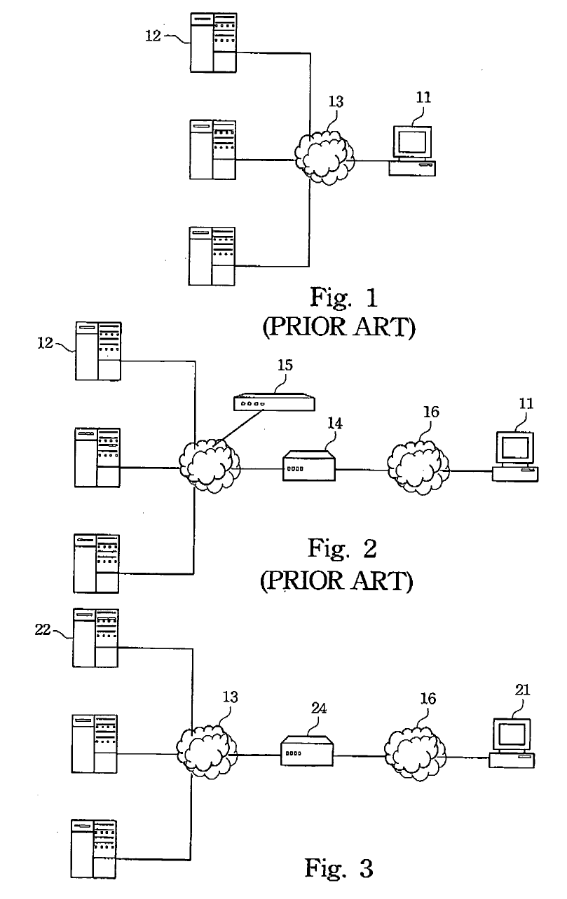

### DETAILED DESCRIPTION OF THE PREFERRED EMBODIMENT

FIG. 3 depicts a schematic diagram of the remote management system of the present invention. Referring to FIG. 3, the system includes at least one client 21, a network device 24 and at least one server 22. The server 22 and the client 21 are coupled to a first network 13 and a second network 16 respectively. The network device 24 with IPMI gateway functionality can be a gateway, a router or a bridge coupled between the first network 13 and the second network 16. In other words, the network device 24 not only connects the first network 13 and the second network 16, but also is capable of routing the IPMI messages transmitted therebetween. Therefore, the remote management system can be implemented in WAN environments without adding the IPMI proxy appliance.

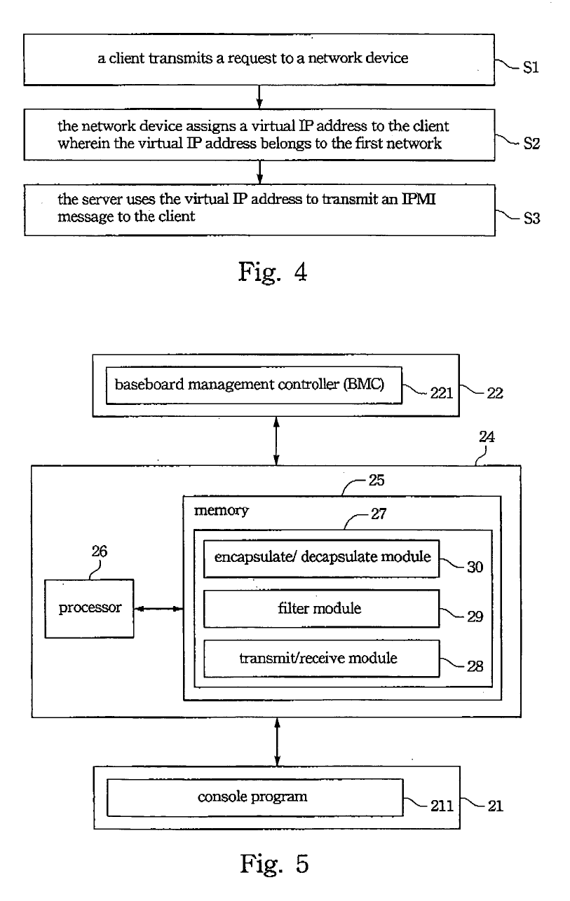

FIG. 4 depicts a flow chart of a method for enabling the client 21 to manage the server 22 remotely via the network device 24 described in FIG. 3. Referring to FIG. 4 and FIG. 3, first, the client 21 transmits a request to the network device 22 (S1). After receiving the request, the network device 24 assigns a virtual IP address to the client 21 wherein the virtual IP address belongs to the first network 13 (S2). Thus, the server 22 can use the virtual IP address to transmit an IPMI message to the client 21 as if they are in the same network (S3).

For example, the first network 13 is a LAN and the second network 16 is a WAN. All the hosts in the first network 13 have the same network ID 10.6.10 and all the hosts in the second network 16 have the same network ID 220.10.1. When the client 21 activates a session with the server 22, the network device 24 assigns the client 21 a virtual IP address having the network ID portion 10.6.10. Then, the client 21 can transmit an IPMI request to the server 22, and the server 22 can transmit an IPMI response to the client 21 via the network device 24 as if they are all in the first network 13. The network device 24 routes IPMI requests and IPMI responses transmitted between the client 21 and the server 22, i.e. the network device 24 is utilized as an IPMI gateway between the first network 13 and the second network 16.

When the IPMI requests and responses are transmitted, the IPMI messages can be encapsulated in Remote Management Control Protocol (RMCP) packets. RMCP is a simple request-response protocol that can be delivered using User Datagram Protocol (UDP) datagrams, which are transmitted using IP datagrams.

An IP datagram can be encapsulated (carried as payload) within another IP datagram. In an embodiment of the present invention, the client 21 and the network device 24 encapsulate/decapsulate the IP datagram including the IPMI message. The process of encapsulation and decapsulation of a datagram is frequently referred to as “tunneling” the datagram. Thus, a virtual IPMI tunnel for transmitting IPMI messages can be built between the client 21 and the network device 24 using the well-known IP tunneling technique.

FIG. 5 depicts a block diagram of the remote management system of the present invention. Referring to FIG. 5, the network device 24 comprises a memory 25 for storing a first software 27 and a processor 26 for executing the first software 27. The first software 27 described herein can be a firmware or an application written in C/C++ language or assembly language. The memory 25 described herein can be any device capable of storing analog or digital information, such as a hard disk, Random Access Memory (RAM), Read Only Memory (ROM), flash memory, a compact disk, a magnetic tape, a floppy disk, and any combination thereof. The processor 26 described herein can be a general-purpose microprocessor or an Application Specific Integrated Circuit (ASIC), which has been designed to implement the first software 27. The client 21 executes a console program 211 and the server 22 includes a baseboard management controller (BMC) 221, which allows the console program 211 to monitor and recover even when the operating system of the server 22 is not loaded, is unstable or is unresponsive. This approach is commonly referred to as providing Out-of-Band access.

Referring to FIG. 5, in an embodiment, the first software 27 comprises a transmit/receive module 28, a filter module 29 and an encapsulate/decapsulate module 30.

When the client 21 transmits an IPMI request to the server 22, the IPMI request is transmitted via at least one IP packet, whose IP header includes an additional header added by the client 21. The source IP address field of the additional header includes the virtual IP address assigned by the network device 24. After the transmit/receive module 28 receives the IP packet, the filter module 29 determines whether the IP packet includes an IPMI message. If not, the filter module 29 filters out the IP packet. If so, the IP packet is passed to the encapsulate/decapsulate module 30. Then, the encapsulate/decapsulate module 30 strips off the additional header and the transmit/receive module 28 transmits the IP packet to the server 22.

When the server 22 transmits an IPMI response to the client 21, the IPMI response is transmitted to the network device 24 via at least one IP packet, whose IP header includes the virtual IP address assigned to the client 21. After the transmit/receive module 28 receives the IP packet, the encapsulate/decapsulate module 30 adds an additional header to the IP packet. The destination IP address field of the additional header includes the real address of the client 21. Then, the IP packet is transmitted to the client 21 by the transmit/receive module 28.

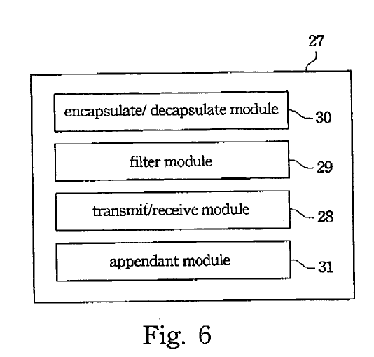

FIG. 6 depicts a block diagram of the first software 27 described in FIG. 5 Referring to FIG. 6, a appendant module can be appended to the first software 27. In an embodiment of the present invention, a first appendant module is appended to the first software 27 for searching the other servers located in the first network 13. The first appendant module sends RMCP Ping packets to every IP address of the first network 13 to complete a blanket search, or it sends RMCP Ping packets to a broadcast address of the first network 13. The first appendant module receives the responses and discovers all the servers located in the first network 13.

The server 22 may be configured to report a variety of error-conditions in the form of Simple Network Management Protocol Trap (SNMP Trap) that are automatically forwarded to a designated device. In an embodiment of the present invention, a second appendant module is appended to the first software 27 for receiving the SNMP Trap sent by the server 22. The second appendant module listens to the SNMP Trap port, such as the UDP port 162, to receive the traps sent by the server 22. Each SNMP Trap may have its own profile dictating how it should be processed, such as to send an e-mail or make a call to the administrator, when the SNMP Trap arrives in the network device 24.

In an embodiment of the present invention, a third appendant module is appended to the first software 27 for retrieving readings of sensors of the server 22. The third appendant module sends the standard IPMI request to communicate with the server 22 for retrieving readings of sensors, such as a temperature sensor, fan speed sensor, voltage sensor, etc. The third appendant module also receives internal server 22 events (system reboot, chassis open, etc.) in the System Event Log (SEL).

In an embodiment of the present invention, a fourth appendant module is appended to the first software 27 for exchanging the IPMI messages to a format acceptable to the web-based browser application, such as Hyper Text Markup Language (HTML) or Extensible Markup Language (XML). Thus, a web-based browser application executing on the client 21 can be utilized as the console program to access the network device 24 and manage the server 22.

The disclosed network device 24 of the invention can simultaneously provide the information of several servers 22 being monitored. Therefore, the administrator can manage the servers 22 centrally and directly by the network device 24.

It is worthy to note that any reference herein to “an embodiment” means that a particular feature, structure, or characteristic described in connection with the embodiment is included in at least one embodiment of the invention. The appearances of the phrase “in an embodiment” in various places in the specification are not necessarily all referring to the same embodiment.

As used herein the term “server” is used in the singular for simplicity of description, however, a “server” can be embodied as a plurality of data processing machines that form a common hardware platform.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A remote management system comprising:
an IPMI enabled server being coupled to a first network;
an IPMI enabled client being coupled to a second network;
a network device being coupled between the first network and the second network for assigning a virtual IP address to the IPMI enabled client, so that the IPMI enabled server can use the virtual IP address to transmit at least one IPMI message to the IPMI enabled client.

2. The remote management system of claim 1, wherein the IPMI enabled server comprises a baseboard management controller (BMC).

3. The remote management system of claim 1, wherein the IPMI enabled client comprises a console program.

4. The remote management system of claim 1, wherein the network device is selected from the group consisting of gateway, router and bridge.

5. The remote management system of claim 1, wherein the first network is a local area network (LAN).

6. The remote management system of claim 1, wherein the second network is a wide area network (WAN).

7. The remote management system of claim 1, wherein the IPMI message is encapsulated in at least one Remote Management Control Protocol (RMCP) packet delivered using at least one User Datagram Protocol (UDP) datagram.

8. The remote management system of claim 7, wherein the UDP datagram is transmitted using at least one IP packet, whose IP header includes the virtual IP address assigned to the IPMI enabled client.

9. A network device for managing an IPMI enabled server using an IPMI enabled client, in which the IPMI enabled server is coupled to a first network, the IPMI enabled client is coupled to a second network, and the network device is coupled between the first network and the second network, the network device comprising:
a memory for storing a first software; and
a processor for executing the first software, wherein the first software assigns a virtual IP address belonging to the first network to the IPMI enabled client, so that the IPMI enabled server can use the virtual IP address to transmit at least one IPMI message to the IPMI enabled client.

10. The network device of claim 9, wherein the first software comprises:
a transmit/receive module for transmitting/receiving a plurality of IP packets to/from the first network and the second network.
a filter module for filtering out the IP packets without the IPMI message from the IP packets received by the transmit/receive module; and
an encapsulate/decapsulate module for encapsulating/decapsulating the IP packets filtered by the filter module.

11. The network device of claim 9, wherein the first software further comprises a first appendant module appended to the first software for searching the other IPMI enabled servers located in the first network.

12. The network device of claim 9, wherein the first software further comprises a second appendant module appended to the first software for receiving at least one SNMP Trap sent by the IPMI enabled server.

13. The network device of claim 9, wherein the first software further comprises a third appendant module appended to the first software for retrieving at least one reading of sensors of the IPMI enabled server.

14. The network device of claim 9, wherein the first software further comprises a fourth appendant module appended to the first software for exchanging the IPMI messages to a format acceptable to a browser application.

15. A remote management method for managing an IPMI enabled server using an IPMI enabled client via a network device, in which the IPMI enabled server is coupled to a first network, the IPMI enabled client is coupled to a second network, and the network device is coupled between the first network and the second network, the remote management method comprising:
transmitting a request from the IPMI enabled client to the network device;
assigning a virtual IP address from the network device to the IPMI enabled client; and
transmitting an IPMI message from the IPMI enabled server to the IPMI enabled client using the virtual IP address.

16. The remote management method of claim 15, further comprising a step of encapsulating the IPMI message using the network device.

17. The remote management method of claim 15, further comprising a step of searching the other IPMI enabled servers located in the first network using the network device.

18. The remote management method according to claim 15, further comprising a step of receiving at least one SNMP Trap using the network device.

19. The remote management method according to claim 15, further comprising a step of retrieving at least one reading of sensors of the IPMI enabled server using the network device.

20. The remote management method according to claim 15, further comprising a step of exchanging the IPMI message to a format acceptable to a browser application using the network device.
